(19) United States
(12) Patent Application Publication
(10) Pub. No.: US 2010/0104414 A1
(43) Pub. Date: Apr. 29, 2010

(54) Workpiece Transport Assembly And Method Of Using Same

(75) Inventors: Gerald E. Chilson, Alanson, MI (US); Daniel T. Emond, West Bloomfield, MI (US); Walter H. Kreimes, Kingston (CA)

Correspondence Address: DICKINSON WRIGHT PLLC, 38525 WOODWARD AVENUE, SUITE 2000, BLOOMFIELD HILLS, MI, 48304-2970, US

(73) Assignee: JERVIS B. WEBB COMPANY, Farmington Hills, MI (US)

(21) Appl. No.: 12/604,610

(22) Filed: Oct. 23, 2009

Related U.S. Application Data
(60) Provisional application No. 61/107,995, filed on Oct. 23, 2008.

(51) Int. Cl. B60F 1/04; B60F 1/00

(52) U.S. Cl. 414/800; 105/72.2

(57) ABSTRACT

A workpiece transport assembly includes an automatic guided vehicle having a guide wheel that drives the automatic guided vehicle along the production floor surface. A frame is releaseably attached to the automatic guided vehicle and defines a work area for assembling a workpiece. The automatic guided vehicle transports the frame to a reaction rail where the frame engages the reaction rail. A drive wheel assembly is mounted to the frame and includes a drive wheel that is movable between a drive wheel engaging position where the drive wheel engages the reaction rail to move the workpiece transport assembly along the reaction rail and a drive wheel disengaging position where the drive wheel disengages the reaction rail. The workpiece transport assembly is driven by at least one of the guide wheel and the drive wheel for movement through the assembly operation.

### CROSS REFERENCE TO RELATED APPLICATION

This utility patent application claims the benefit of U.S. Provisional Patent Application Ser. No. 61/107,995 filed Oct. 23, 2008, entitled “Workpiece Transport Assembly and Method of Using Same,” the entire disclosure of the application being considered part of the disclosure of this application, and hereby incorporated by reference.

### BACKGROUND OF THE INVENTION

1. Field of the Invention

The present invention relates to a workpiece transport assembly and a method of using the same.

2. Description of the Prior Art

The present invention relates to moveable transport systems or carriers used in vehicle, tracker, airplane or other manufacturing operations which permit assembly workers to walk about the transport system and perform various assembly operations on a workpiece being moved by such transport system. These carriers are widely used to move workpieces of various shapes and sizes, such vehicle bodies or airplane fuselages, throughout manufacturing and storage facilities. It is known in the prior art to transport carriers through the manufacturing or storage area via a conveyor system. The conveyor system can include a power and free (PF) system, an overhead PF system, a friction drive system (FDS), an overhead FDS, an electrified monorail system (EMS), an overhead EMS, etc. Such conveyor systems are bulky, costly and take up much needed space in a manufacturing facility.

### SUMMARY OF THE INVENTION AND ADVANTAGES

The subject invention relates to a workpiece transport assembly having a reaction rail that is spaced from a production floor surface. The reaction rail defines a travel path along an axis. The assembly includes an automatic guided vehicle having a guide wheel that drives the automatic guided vehicle along the production floor surface. A frame is releaseably attached to the automatic guided vehicle and defines a work area for assembling a workpiece. The automatic guided vehicle transports the frame to the reaction rail. The workpiece transport assembly includes a drive wheel assembly that is mounted to the frame. The drive wheel assembly includes a drive wheel that is movable between a drive wheel engaging position where the drive wheel engages the reaction rail to move the workpiece transport assembly along the reaction rail and a drive wheel disengaging position where the drive wheel disengages the reaction rail. The workpiece transport assembly is driven by at least one of the guide wheel and the drive wheel for movement through the assembly operation.

The present invention further provides for a method of transporting a workpiece on a workpiece transport assembly. The workpiece transport assembly includes a frame with a drive wheel assembly and at least one guide roller assembly attached thereto. The workpiece transport assembly further includes an automatic guided vehicle that releaseably attaches to the frame. To begin, the automatic guided vehicle releaseably engages the frame. The automatic guided vehicle with the frame releaseably engaged thereto is then guided into a production area having a reaction rail where the frame is aligned with the reaction rail. Next, the drive wheel of the drive wheel assembly is moved from a drive wheel disengaging position to a drive wheel engaging position. The workpiece transport assembly is then driven with the drive wheel assembly along the reaction rail. Next, the drive wheel of the drive wheel assembly is moved from the drive wheel engaging position to the drive wheel disengaging position. The frame is then guided from the reaction rail with the automatic guided vehicle.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view from the bottom of an exemplary workpiece transport assembly according to the subject invention;

FIG. 2 is a side view of the workpiece transport assembly shown in FIG. 1;

FIG. 3 is a front view of the workpiece transport assembly shown in FIG. 1;

FIG. 4 is a top view of the workpiece transport assembly shown in FIG. 1;

FIG. 5 is a side view of a second exemplary workpiece transport assembly according to the subject invention; and

FIG. 6 is a front view of a third exemplary workpiece transport assembly according to the subject invention.

### DETAILED DESCRIPTION OF THE INVENTION

A workpiece transport assembly 20 is generally shown in the Figures for moving a workpiece through an assembly operation. The workpiece transport assembly 20 includes an automatic guided vehicle 22 for driving on a production floor surface 24, a frame 26 for attachment to the workpiece and a drive assembly for driving the workpiece transport assembly 20 as an assembly, or the frame 26 alone, against a reaction rail 28 along a travel path 30 along an axis A.

The frame 26 is releaseably attachable to both of the automatic guided vehicle 22 and the reaction rail 28. The frame 26 includes at least one crossbar 32, preferably a plurality of crossbars 32, that extends horizontally for releaseably attaching to the automatic guided vehicle 22, the workpiece and a guide roller assembly 34. The plurality of crossbars 32 define a work area 36 where the workpiece is assembled. The frame 26 includes a hitch assembly for releaseably attaching the automatic guided vehicle 22 to the frame 26. The hitch assembly is attached, or formed with, at least a part of one of the plurality of crossbars 32 at a predetermined position thereon.

The frame 26 is provided for mounting the workpiece thereto to permit workers in a certain production area to work on the workpiece while the workpiece is moving along the travel path 30. The workpiece may include for example, without limitation, a vehicle, vehicle body, furniture, tractor or airplane.

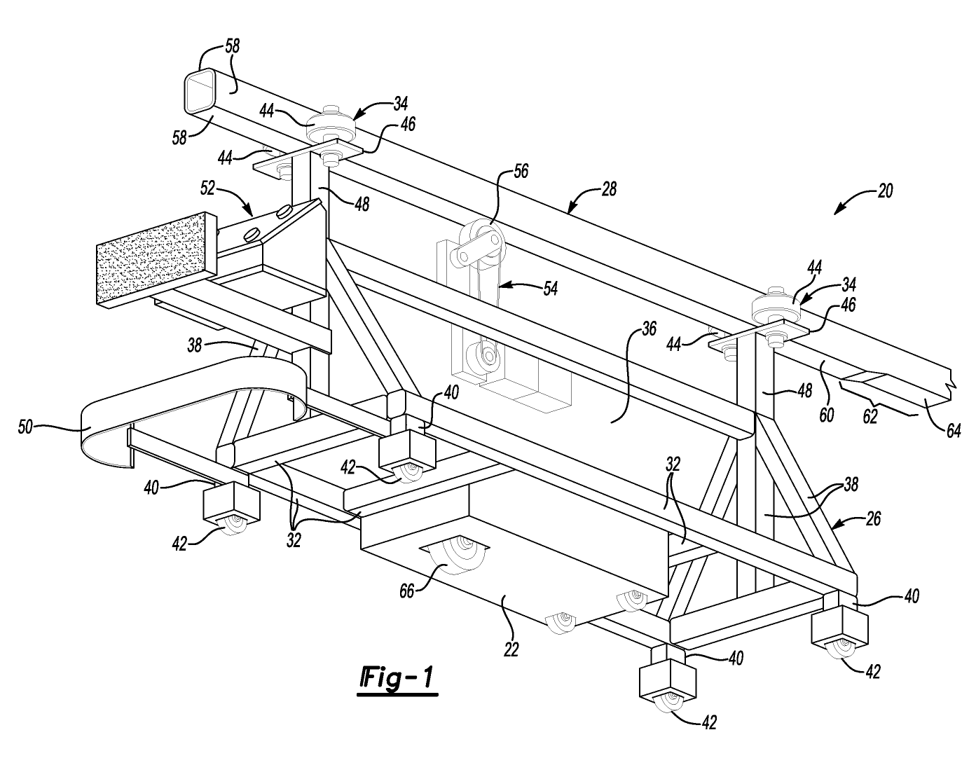

At least one support beam 38 extends from the work area 36 toward the reaction rail 28. In the exemplary embodiment, a plurality of support beams 38 are shown. At least one leg portion 40 extends from the work area 36 toward the production floor surface 24. In the exemplary embodiment, a plurality of leg portions 40 are shown. At least one roller wheel 42 extends from the frame 26 to engage the production floor surface 24 to move the frame 26 along the travel path 30. In the exemplary embodiment, a plurality of roller wheels 42 are shown and the plurality of roller wheels 42 engage the frame 26 at the plurality of leg portions 40. The plurality of roller wheels 42 permit the frame 26 to roll on the production floor surface 24. The embodiment shown in FIG. 1 includes four roller wheels 42, however, it should be appreciated that other amounts of roller wheels 42 may be selected depending on other factors, including, for example, the weight and size of the workpiece.

At least one guide roller assembly 34 extends from the frame 26 to engage the reaction rail 28. The at least one guide roller assembly 34 includes at least two guide rollers 44 each positioned on opposite sides of the reaction rail 28 to provide lateral support to the frame 26, and more broadly to the workpiece transport assembly 20. The embodiment shown in FIG. 1 shows two guide roller assemblies 34 provided at two locations spaced axially apart. It should be appreciated that the location of each guide roller assembly 34 and the amount of such roller assemblies utilized may vary depending on the lateral support needed. The embodiment shown in FIG. 1 also shows the guide roller assembly 34 mounted vertically above the work area 36 of the frame 26 and adjacent to a reaction rail 28 located vertically above the production floor surface 24. It should be appreciated that the guide roller assembly 34 may also be mounted on the frame 26 in other locations such as extending laterally from the frame 26 and parallel with the axis A of the travel path 30 as shown in FIG. 6.

The guide roller assembly 34 includes a support bracket 46 that secures the guide rollers 44 to the frame 26. A guide roller support bar 48 extends from the frame 26 to the support bracket 46 for securing the guide roller assembly 34 to the frame 26.

The frame 26 may include at least one frame bumper 50 that is mounted to the frame 26. In the exemplary embodiment, the frame bumper 50 is mounted to a front portion of the frame 26, but may be mounted to any of the sides of the frame 26. It should be appreciated that such a frame bumper 50 may be useful for mounting the guidance systems 52 and/or for pushing each transport assembly along in the event of a failure of an adjacent assembly. The frame 26 may include multiple bumpers disposed on the side portions of the frame 26. Further, the frame bumper 50 may be pivotably mounted to at least one side of the frame 26 about a horizontal axis.

The frame bumper 50 may be removed from the frame 26. In this embodiment, the automatic guided vehicle 22 is permitted to move underneath the frame 26 both at a rear portion of the frame 26 and a front portion of the frame 26. As a result, it may be possible to provide for the automatic guided vehicle 22 to be driven into and out of engagement with the frame 26 in one direction. In addition, the automatic guided vehicle 22 can be driven into and out of engagement with the frame 26 in one direction even while the frame 26 is being driven by the drive wheel assembly 54. In this embodiment, it is possible to permit the frame 26 to be driven at slow speeds such as one foot per hour while detaching the automatic guided vehicle 22 from the frame 26 in order to more efficiently use the automatic guided vehicle 22 during this portion of the production area for another purpose or for use with another frame 26.

The drive wheel assembly 54 is mounted to the frame 26. The drive wheel assembly 54 includes a drive wheel 56 that is capable of moving between a drive wheel engaging position and a drive wheel disengaging position. The drive wheel 56 engages the reaction rail 28 in the drive wheel 56 engaging position for moving the workpiece transport assembly 20 along the reaction rail 28.

The drive assembly includes a drive motor, gear reducer, tensioner and a spring loaded drive wheel 56. Such an arrangement is more commonly known as a friction drive system. In FIG. 1, the drive assembly is mounted to a portion of the frame 26 extending vertically above the crossbar 32 and adjacent the reaction rail 28. It should be appreciated that the drive assembly may also be mounted to the frame 26 in other locations such as extending laterally from the frame 26 and parallel with the axis A of the travel path 30 such as the embodiment shown in FIG. 6. It should also be appreciated that the although the spring loaded drive wheel 56 is shown mounted for friction engagement with the bottom portion of the reaction wheel, the drive wheel 56 may also be mounted for engagement with any other surface of the reaction rail 28 such as the top surface.

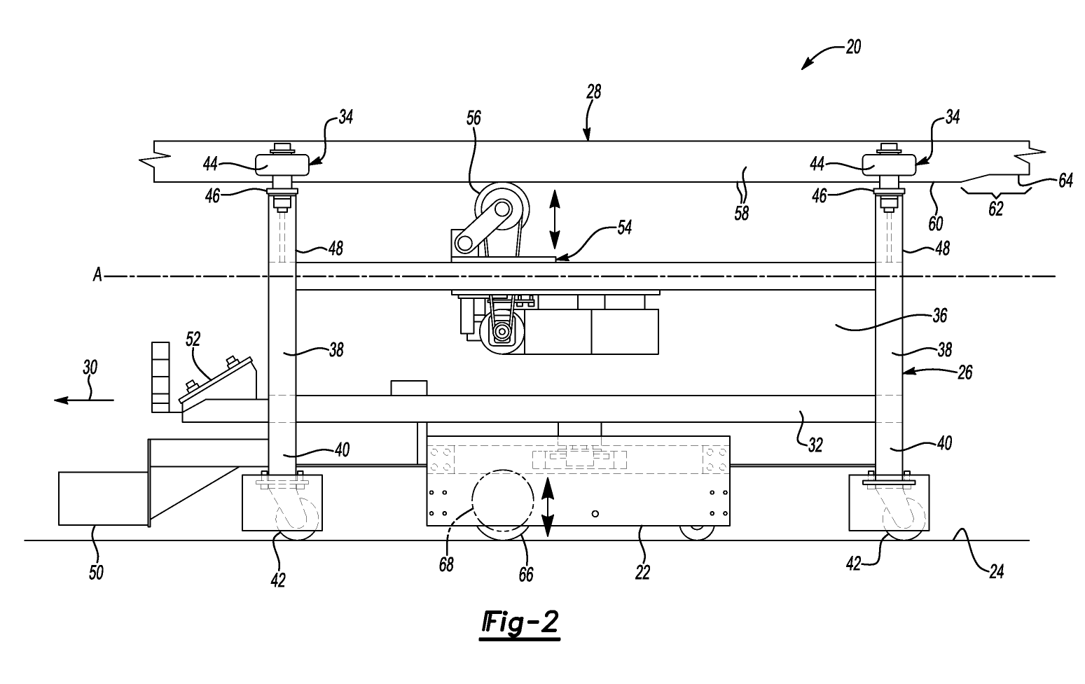

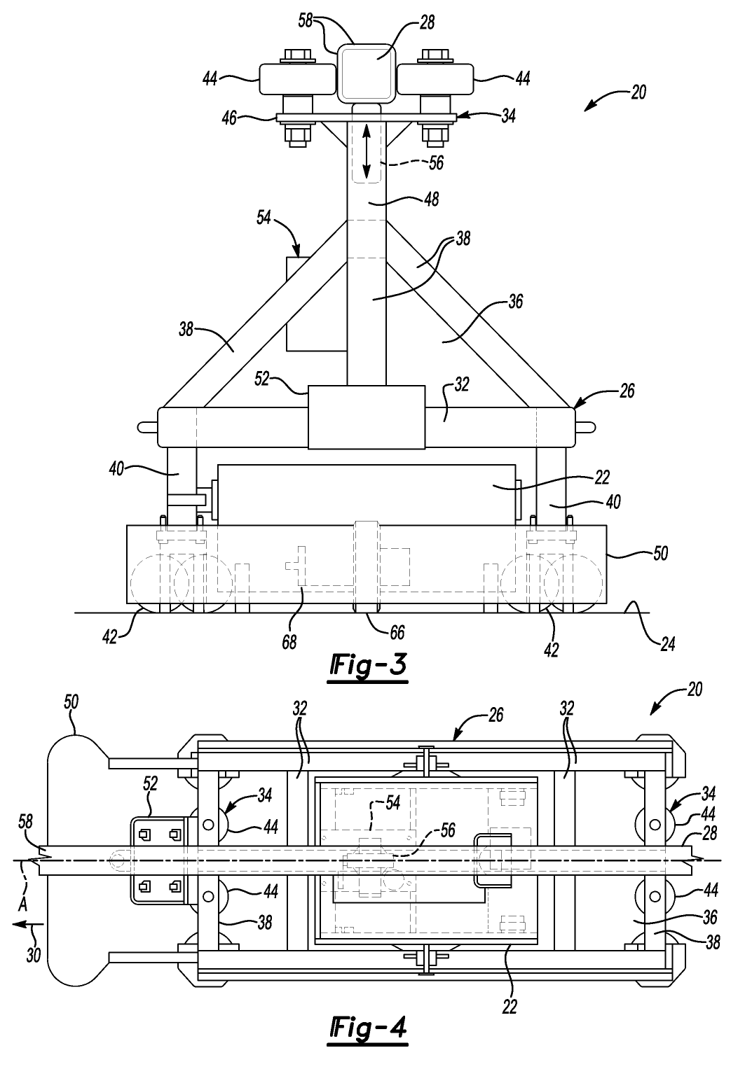

The reaction rail 28 includes a plurality of reaction surfaces 58. In the exemplary embodiment, the reaction rail 28 is generally square, but may be any shape and material known in the art. The reaction rail 28 includes a main portion 60 that is generally square and a staging portion 62 that defines a void 64. The staging portion 62 limits the contact between the reaction rail 28 and the drive wheel 56 at the staging portion 62. As seen in FIGS. 1-5, the reaction rail 28 is typically spaced vertically from the work area 36.

The reaction rail 28 may be spaced horizontally from the work area 36 as shown in FIG. 6. In this exemplary embodiment, at least one support bar extends laterally out from a side of the frame 26 such that the guide roller assembly 34 and drive wheel assembly 54 may be adjacent to a reaction rail 28 positioned laterally or horizontally with respect to the workpiece transport assembly 20.

The reaction rail 28 may be designed to inductively transmit power to the drive wheel assembly 54 and in turn also to charge a battery mounted on the automatic guided vehicle 22 while receiving power from the inductive reaction rail 28. Alternatively, the battery in the automatic guided vehicle 22 may provide power to the drive wheel assembly 54.

Automatic guided vehicles 22 (AGVs) are used throughout the material handling industry to transport loads. The term automatic guided vehicle 22 is commonly used to refer to robust vehicle designs having any of a number of available automated guidance systems 52. Automatic guided carts (AGCs) is a term commonly used to refer to a less robust vehicle used for similar but less complicated applications. Throughout this application, including the claims, the term automatic guided vehicle 22 shall mean and include both AGVs and AGCs, as well as any other vehicle that is automatically guided.

The automatic guided vehicle 22 includes a guide wheel 66 that is driven by a guide motor to move or guide the automatic guided vehicle 22 along the production floor surface 24. The automatic guided vehicle 22 may be used to transport the frame 26 on the production floor surface 24 from one area of a production facility, such as the end of an assembly area, to another production area such as the beginning of the assembly area, or a storage location. The automatic guided vehicle 22 is releaseably attached to the frame 26 to provide for interchangeability of an automatic guided vehicle 22 with any given frame 26.

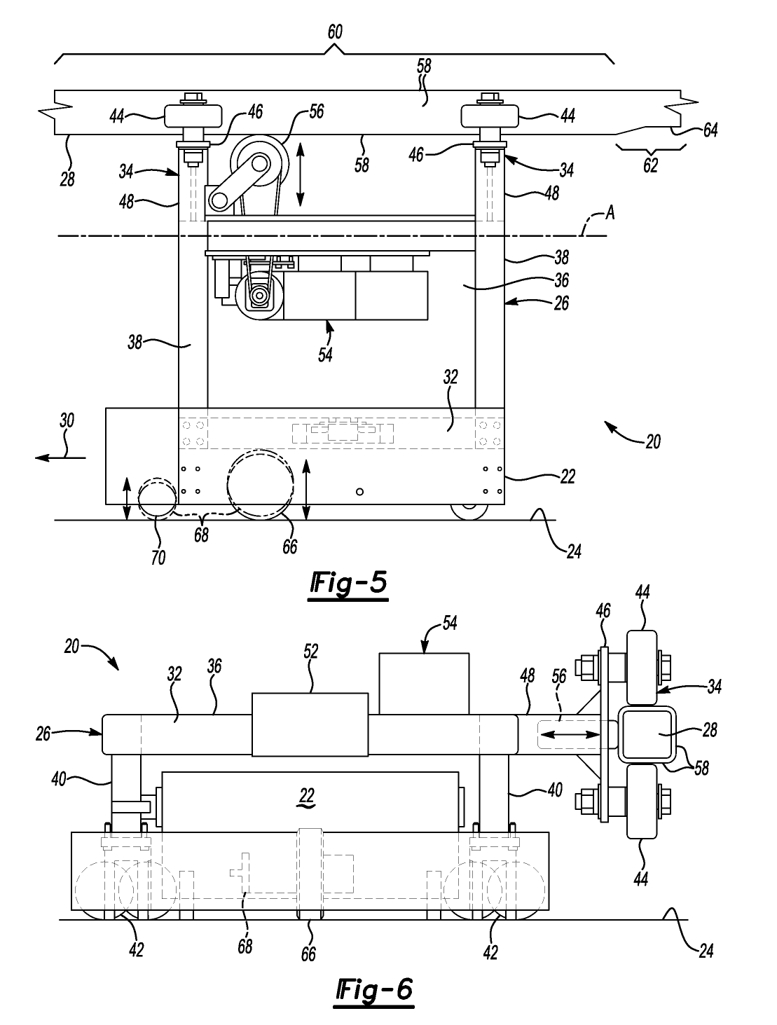

A guide wheel lifter 68 may be provided on the automatic guided vehicle 22 or mounted to the frame 26 to selectively lift the guide wheel 66 into or out of engagement with the production floor surface 24. It should be appreciated that the guide wheel 66 may also be engaged and disengaged by other known means besides the guide wheel lifter 68. In the exemplary embodiment, the guide wheel lifter 68 is secured to the frame 26 for moving the guide wheel 66 between the guide wheel 66 engaging position and the guide wheel disengaging position. In an alternative embodiment, as shown in FIG. 5, the guide wheel lifter 68 may be secured to the automatic guided vehicle 22. In such an assembly, a caster wheel 70 is spaced from the production floor surface 24 when the guide wheel 66 is in the guide wheel engaging position. The guide wheel lifter 68 is movable to engage the caster wheel 70 with the production floor surface 24 when the guide wheel 66 is moved into the guide wheel disengaging position.

As is the case with most automatic guided vehicles 22, the automatic guided vehicle 22 can be provided with on-board or off-board electronics including, for example, on-board computer and on-board guidance systems 52 or off-board guidance systems 52. The guidance system 52 in communication with the automatic guided vehicle 22 for controlling the movement of the automatic guided vehicle 22 along the production floor surface 24.

In the exemplary embodiment, the guidance system 52 is shown mounted to the frame 26, but the guidance system 52 may be mounted to the automatic guided vehicle 22. A variety of guidance systems 52 may be used with the automatic guided vehicle 22. These guidance systems 52 generally include inertial guidance, magnetic guidance, active guide wire guidance, laser guidance and optical guidance systems 52. Magnetic guidance systems 52 typically include magnetic tape or magnetic devices installed on the factory floor permitting the automatic guided vehicles 22 to follow the tape using magnetic sensors. Laser and optical guidance systems 52 generally search for targets installed on the walls or other support structures of a production facility. By finding and triangulating or comparing the location of these targets, the guidance system 52 determines the location of the automatic guided vehicle 22 Also, some automatic guided vehicles 22 use inertial guidance as the primary guidance system 52 for each automatic guided vehicle 22. Other guidance systems 52 may be used with the present invention including the use of some combinations of the above systems such as the use of an inertial guidance system 52 in communication with one or more laser systems.

In the exemplary embodiment, the guidance system 52 is mounted with the frame 26 and includes an optic beam mounted in a bumper like arrangement on at least one end of the frame 26. In operation, the automatic guided vehicle 22 is positioned below the frame 26 and releaseably attached thereto. It should be appreciated that the automatic guided vehicle 22 may be programmed to automatically drive underneath the frame 26 into the appropriate mating position with the frame 26. As is known in the industry, the automatic guided vehicle 22 may be operated at speeds ranging from 10 feet per minute to 300 feet per minute. After the automatic guided vehicle 22 is attached to the frame 26, the automatic guided vehicle 22 may further drive the entire workpiece transport system to a production area for alignment of the guide roller assembly 34 and the drive wheel assembly 54 with the reaction rail 28. When the automatic guided vehicle 22 is appropriately aligned and positioned with the reaction rail 28, the guide wheel lifter 68 is engaged causing the guide wheel 66 to no longer be engaged with the production floor surface 24 and the drive wheel assembly 54 is engaged to apply a load against the reaction rail 28 to thereby cause the workpiece transport system to be driven by the drive wheel assembly 54 along at least a portion of the production area having the reaction rail 28. The workpiece transport system when driven with the drive wheel assembly 54 can be driven at extremely slow speeds such as one foot per hour. It should be appreciated that the speed selection depends on many different factors including, for example, the size and weight of the workpiece, and/or the amount of operations required at a certain portion of the travel path 30. At the end of the reaction rail 28, the guide wheel lifter 68 is disengaged causing the automatic guided vehicle 22 drive wheel 56 to engage the floor surface thereby causing the workpiece transport system to be driven by the automatic guided vehicle 22 drive wheel 56 and not the drive wheel assembly 54 on the frame 26. At this point, for example, the automatic guided vehicle 22 may assist in the production work flow by, for example, transporting the frame 26 to another portion of the production area such as the beginning of the production line.

It should be appreciated that the automatic guided vehicle 22 may releaseably attach and detach from the frame 26 at any point during the assembly operation. For example, the automatic guided vehicle 22 may be configured to drive under the frame 26 to releaseably attach to the frame 26 at a first location and to detach from the frame 26 at a second location to drive-out from under the frame. The first location may include, but is not limited to, a storage location, an end of the assembly operation, or any point along the assembly operation. The second location may include, but is not limited to a storage location, the beginning of the assembly operation, or any point along the assembly operation.

Electronic communications between the automatic guided vehicle 22, the frame 26 and a central production area control may also be provided to monitor and/or control certain operations of the automatic guided vehicle 22 and the frame 26 including, for example, the location in the production area, determining which frame 26 is mounted to which automatic guided vehicle 22, relationship guidance between other workpiece transport assemblies 20 moving in the production area, signaling when to operate the driven wheel assembly or the automatic guided vehicle 22 drive wheel 56.

FIG. 5 is a side view of another embodiment of the work piece transport system having the frame 26 releaseably mounted to the automatic guided vehicle 22, however, the frame 26 is supported by the automatic guided vehicle 22 and is not supported separately with the use of roller wheels 42 as described for the embodiment shown in FIGS. 1-4. Similar to the embodiment in FIGS. 1-4, this embodiment also includes the frame 26 having guide rollers 44 and a drive wheel assembly 54 mounted thereto for driving with respect to the reaction rail 28. Further, this embodiment includes the guide wheel lifter 68 mounted to the automatic guided vehicle 22 itself and not to the frame 26.

The present invention further provides for a method of transporting a workpiece on a workpiece transport assembly 20. The workpiece transport assembly 20 includes a frame 26 with a drive wheel assembly 54 and at least one guide roller assembly 34 attached thereto. The workpiece transport assembly 20 further includes an automatic guided vehicle 22 that releaseably attaches to the frame 26. To begin, the automatic guided vehicle 22 is guided along a production floor surface 24 to a position adjacent to the frame 26. Next, the automatic guided vehicle 22 is releaseably engaged to the frame 26. The automatic guided vehicle 22 with the frame 26 releaseably engaged thereto is then guided into a production area having a reaction rail 28 where the frame 26 is aligned with the reaction rail 28. The frame 26 includes a guide roller assembly 34 for aligning the frame 26 with the reaction rail 28.

The drive wheel 56 of the drive wheel assembly 54 is next moved from a drive wheel disengaging position to a drive wheel engaging position. The method includes the optional step of moving the guide wheel 66 of the automatic guided vehicle 22 from a guide wheel 66 engaging position to a guide wheel disengaging position. This step can be performed at any time relative to the step of moving the drive wheel 56 from the drive wheel 56 disengaging position to the drive wheel engaging position, but in the exemplary embodiment, these steps are performed simultaneously. The workpiece transport assembly 20 is then driven with the drive wheel assembly 54 along the reaction rail 28.

The drive wheel 56 of the drive wheel assembly 54 is next moved from the drive wheel engaging position to the drive wheel disengaging position. The method includes the optional step of moving the guide wheel 66 of the automatic guided vehicle 22 from a guide wheel disengaging position to a guide wheel engaging position. This step can be performed at any time relative to the step of moving the drive wheel 56 from the drive wheel engaging position to the drive wheel 56 disengaging position, but in the exemplary embodiment, these steps are preformed simultaneously. The frame 26 is then guided from the reaction rail 28 with the automatic guided vehicle 22.

It should be appreciated that the workpiece transport assembly 20 can be used in a variety of applications beyond the illustrated applications.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. A workpiece transport assembly for moving a workpiece through an assembly operation having a production floor surface and reaction rail that defines a travel path along an axis comprising:
an automatic guided vehicle having a guide wheel for driving said automatic guided vehicle along the production floor surface;
a frame being releaseably attachable to said automatic guided vehicle and defining a work area for assembling the workpiece; and
a drive wheel assembly mounted to said frame and having a drive wheel movable between a drive wheel engaging position for engaging the reaction rail to move said workpiece transport assembly along the reaction rail and a drive wheel disengaging position for disengaging said drive wheel from the reaction rail;
wherein said workpiece transport assembly is driven by at least one of said guide wheel and said drive wheel for movement through the assembly operation.

2. The workpiece transport assembly as set forth in claim 1 wherein said guide wheel is movable between a guide wheel engaging position for controlled movement of said automatic guided vehicle along the production floor surface and a guide wheel disengaging position for stopping the controlled movement of said automatic guided vehicle along the production floor surface.

3. The workpiece transport assembly as set forth in claim 2 wherein said guide wheel is moved into the guide wheel disengaging position as the drive wheel is moved into the drive wheel engaging position.

4. The workpiece transport assembly as set forth in claim 2 further including a guide wheel lifter for moving said guide wheel between the guide wheel engaging position and the guide wheel disengaging position.

5. The workpiece transport assembly as set forth in claim 4 wherein said guide wheel lifter is secured to said frame for moving said guide wheel between the guide wheel engaging position and the guide wheel disengaging position.

6. The workpiece transport assembly as set forth in claim 4 wherein said guide wheel lifter is secured to said automatic guided vehicle.

7. The workpiece transport assembly as set forth in claim 6 wherein said guide wheel lifter includes a caster wheel spaced from said production floor surface when said guide wheel is in the guide wheel engaging position, said guide wheel lifter being movable to engage said caster wheel with said production floor surface when said guide wheel is in the guide wheel disengaging position.

8. The workpiece transport assembly as set forth in claim 1 wherein said frame includes at least one crossbar to define said work area.

9. The workpiece transport assembly as set forth in claim 8 wherein said automatic guided vehicle releaseably attaches to at least one crossbar of said frame.

10. The workpiece transport assembly as set forth in claim 1 further including a reaction rail and wherein said frame includes at least one support beam extending from said work area toward said reaction rail.

11. The workpiece transport assembly as set forth in claim 1 further including at least one roller wheel extending from said frame for engaging the production floor surface to move said frame along the production floor surface.

12. The workpiece transport assembly as set forth in claim 11 wherein said frame includes at least one leg portion extending from said work area toward said production floor surface and wherein said at least one roller wheel engages said frame at said at least one leg portion.

13. The workpiece transport assembly as set forth in claim 1 further including a reaction rail being generally square and having a plurality of reaction surfaces.

14. The workpiece transport assembly as set forth in claim 13 wherein said reaction rail is spaced vertically from said work area.

15. The workpiece transport assembly as set forth in claim 13 wherein said reaction rail is spaced horizontally from said work area.

16. The workpiece transport assembly as set forth in claim 13 further including a plurality of frames disposed along said reaction rail.

17. The workpiece transport assembly as set forth in claim 13 further including at least one guide roller assembly extending from said frame to engage said reaction rail and having at least two guide rollers disposed on opposing reaction surfaces of said reaction rail for providing support to said frame as said frame moves along said travel path.

18. The workpiece transport assembly as set forth in claim 17 further including a plurality of guide roller assemblies spaced axially along said reaction rail.

19. The workpiece transport assembly as set forth in claim 17 wherein said guide roller assembly includes a support bracket for securing said guide rollers and a guide roller support bar extending from said frame to at least one of said support brackets of said frame for securing said guide roller assembly to said frame.

20. The workpiece transport assembly as set forth in claim 13 wherein said reaction rail includes a main portion being generally square and a staging portion defining a void for limiting the contact between said reaction rail and said drive wheel at said staging portion.

21. The workpiece transport assembly as set forth in claim 1 further including a guidance system in communication with said automatic guided vehicle for controlling the movement of said automatic guided vehicle along the production floor surface.

22. The workpiece transport assembly as set forth in claim 21 wherein said guidance system is disposed upon said frame and in communication with said automatic guided vehicle for controlling the movement of said automatic guided vehicle along the production floor surface.

23. A workpiece transport assembly for moving a workpiece through an assembly operation having a production floor surface and reaction rail that defines a travel path along an axis comprising:
a frame defining a work area for assembling the workpiece and having a drive wheel assembly mounted thereon, said drive wheel assembly having a drive wheel movable between a drive wheel engaging position for engaging the reaction rail to move said workpiece transport assembly along the reaction rail and a drive wheel disengaging position for disengaging said drive wheel from the reaction rail; and
an automatic guided vehicle having a guide wheel for driving said automatic guided vehicle along the production floor surface, said automatic guided vehicle being configured for driving under said frame to releaseably attach to said frame at a first location and for detaching from said frame at a second location to drive-out from under said frame;
wherein said workpiece transport assembly is driven by at least one of said guide wheel and said drive wheel for movement through the assembly operation.

24. The workpiece transport assembly as set forth in claim 23 wherein said guide wheel is movable between a guide wheel engaging position for controlled movement of said automatic guided vehicle along the production floor surface and a guide wheel disengaging position for stopping the controlled movement of said automatic guided vehicle along the production floor surface.

25. The workpiece transport assembly as set forth in claim 24 wherein said guide wheel is moved into the guide wheel disengaging position as the drive wheel is moved into the drive wheel engaging position.

26. The workpiece transport assembly as set forth in claim 24 further including a guide wheel lifter for moving said guide wheel between the guide wheel engaging position and the guide wheel disengaging position.

27. The assembly as set forth in claim 23 wherein the first location is one of a storage location, end of the assembly operation, and any point along the assembly operation.

28. The assembly as set forth in claim 23 wherein the second location is one of a storage area, beginning of the assembly operation, and any point along the assembly operation.

29. A method of transporting a workpiece on a workpiece transport assembly having a frame with a drive wheel assembly and at least one guide roller assembly attached thereto and an automatic guided vehicle for engaging the frame and having a guide wheel comprising the steps of:
releaseably engaging the automatic guided vehicle to the frame;
guiding the automatic guided vehicle with the frame releaseably engaged thereto into a production area having a reaction rail;
aligning the frame with the reaction rail;
moving the drive wheel of the drive wheel assembly from a drive wheel disengaging position to a drive wheel engaging position;
driving the workpiece transport assembly with the drive wheel assembly along the reaction rail;
moving the drive wheel of the drive wheel assembly from the drive wheel engaging position to the drive wheel disengaging position; and
guiding the frame from the reaction rail with the automatic guided vehicle.

30. The method as set forth in claim 29 further including the step of moving the guide wheel of the automatic guided vehicle from a guide wheel engaging position to a guide wheel disengaging position.

31. The method as set forth in claim 30 wherein the moving the guide wheel from the guide wheel engaging position to the guide wheel disengaging position step is performed simultaneously to the moving the drive wheel step from the drive wheel disengaging position to the drive wheel engaging position.

32. The method as set forth in claim 30 further including the step moving the guide wheel of the automatic guided vehicle from the guide wheel disengaging position to the guide wheel engaging position.

33. The method as set forth in claim 32 wherein the moving the guide wheel from the guide wheel disengaging position to the guide wheel engaging position step is performed simultaneously to the moving the drive wheel from the drive wheel disengaging position to the drive wheel engaging position step.

34. The method as set forth in claim 29 further including the step of guiding the automatic guided vehicle along a production floor surface to a position adjacent to the frame.

35. The method as set forth in claim 29 wherein the aligning the frame step is further defined as aligning a guide roller assembly with the reaction rail.

36. The method as set forth in claim 29 further including the step of disengaging the automatic guided vehicle from the frame.

37. The method as set forth in claim 36 wherein the disengaging the automatic guided vehicle step is further defined as disengaging the automatic guided vehicle from the frame during the driving the workpiece transport assembly with the drive wheel assembly along the reaction rail step.

38. The method as set forth in claim 37 further including the step of releaseably reengaging the automatic guided vehicle to frame during the driving the workpiece transport assembly with the drive wheel assembly along the reaction rail step.
